(19) United States
(12) Patent Application Publication
(10) Pub. No.: US 2022/0060563 A1
(43) Pub. Date: Feb. 24, 2022

(54) INTERCONNECTED DEVICE NETWORK

(71) Applicant: BearCom Group, Inc., Garland, TX (US)

(72) Inventor: Michael Butler, Arlington, TX (US)

(21) Appl. No.: 17/409,454

(22) Filed: Aug. 23, 2021

Related U.S. Application Data
(60) Provisional application No. 63/068,505, filed on Aug. 21, 2020.

(51) Int. Cl. H04L 29/08; H04L 29/06

(52) U.S. Cl. CPC H04L 67/327; H04L 67/147; H04L 69/22

(57) ABSTRACT

An interconnected device network and related methods is provided. The interconnected device network includes a first remote device configured to transmit a telemetry message, a telemetry control station configured to receive the telemetry message comprising a unique identification associated with the telemetry control station, a telemetry feature, and an action command, a control module configured to receive the telemetry message from the telemetry control station, decode the telemetry message, and generate a machine language protocol payload from the telemetry message in accordance with the action command, and a machine language broker configured to receive the machine language protocol payload and transmit the machine language protocol payload to at least one second remote device.

### CROSS-REFERENCE TO RELATED APPLICATIONS

This application claims the benefit of U.S. Provisional Application No. 63/068,505, filed on Aug. 21, 2020, which is incorporated by reference herein in its entirety.

### FIELD OF THE INVENTION

The present invention relates generally to an interconnected device network and related methods.

### BACKGROUND OF THE INVENTION

In recent years, the use of Internet-of-Things (“IoT”) interconnected devices has become more and more prolific. Generally speaking, IoT interconnected devices operate using a common machine language or protocol so that messages or actions may be communicated with devices utilizing low processor usage, small memory footprint, and minimal battery requirements. Separately, the use of traditional communication devices and networks, and in particular, traditional two-way radios (i.e., push-to-talk (“PTT”) radios), employ a communication protocol distinct from devices on an IoT interconnected device network. These two technologies have not intersected.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

A common machine language or protocol to allow multiple devices from multiple proprietary sources to “speak” the same machine language is implemented. In an embodiment, the machine language or protocol is MQ Telemetry Transport, and may be implemented utilizing Node-RED, a programming tool for wiring together hardware devices, APIs and online services, and ESP 32, a development board, a System-on-a-Chip (SoC) designed to provide physical interconnectivity between devices and processing capabilities to the interconnected device network, among other things. The interconnected device network can provide edge monitoring, mobile command monitoring, NOC services, AI systems, RDAC message-capable nodes, and monitoring of remote equipment, among other things.

In accordance with a first aspect of the present invention, there is provided an interconnected device network that includes a first remote device configured to transmit a telemetry message, a telemetry control station configured to receive the telemetry message comprising a unique identification associated with the telemetry control station, a telemetry feature, and an action command, a control module configured to receive the telemetry message from the telemetry control station, decode the telemetry message, and generate a machine language protocol payload from the telemetry message in accordance with the action command, and a machine language broker configured to receive the machine language protocol payload and transmit the machine language protocol payload to at least one second remote device.

The interconnected device network may include an event-driven application configured to provide accessibility between the control station, the at least one remote device, and application programming interfaces, wherein at least two of the control station, the at least one remote device, and the application programming interfaces do not communicate through the same machine language protocol.

The control module may be configured to receive a voltage input, wherein the machine language protocol payload is generated by the control module when the control module receives a change in the voltage input. The interconnected device network may include a repeater configured to relay the telemetry message from the first remote device to the telemetry control station. The telemetry control station may be an MQ telemetry transport control station. The event-driven application may be node-RED.

The machine language broker may be further configured to maintain a subscribed list, wherein the subscribed list tracks a topic and the at least one second remote device subscribed to the topic. The machine language protocol payload may be a portion of a machine language protocol packet configured to be transmitted and received through a wireless network.

In accordance with another aspect of the present invention, there is provided a method of providing a common machine language network including steps of transmitting a telemetry message from a first remote device, the telemetry message comprising a unique identification associated with a telemetry control station, a telemetry feature, and an action command, receiving the telemetry message at the telemetry control station, the telemetry control station configured to decode the telemetry message and change a voltage output in response to the action command, generating a machine language protocol payload in response to the voltage output change, wherein the payload is configured to be transmitted to a machine language protocol broker, receiving the payload at the machine language protocol broker, and transmitting the machine language protocol payload to at least one second remote device via the machine language protocol broker. The method may include the step of relaying the telemetry message from the first remote device to the telemetry control station.

### BRIEF DESCRIPTION OF THE DRAWINGS

The invention may be more readily understood by referring to the accompanying drawings in which:

FIG. 1 is a system block diagram of an interconnected device network in accordance with a preferred embodiment of the present invention;

FIG. 2 is a system block diagram of an interconnected device network in accordance with a preferred embodiment of the present invention;

FIG. 3 is a system block diagram illustrating a machine language protocol in accordance with a preferred embodiment of the present invention;

FIG. 4 is a system block diagram of a telemetry control station 40 in accordance with a preferred embodiment of the present invention;

FIG. 5 is a diagram of an event-driven application graphical user interface in accordance with a preferred embodiment of the present invention;

FIG. 6 is a diagram of a report generated by an event-driven application in accordance with a preferred embodiment of the present invention;

FIG. 7 is a flow diagram of a method of providing a common machine language network in accordance with a preferred embodiment of the present invention;

FIG. 8 is a diagram of a telemetry command programming tool in accordance with a preferred embodiment of the present invention; and

FIG. is 9 a diagram of a telemetry command programming tool in accordance with a preferred embodiment of the present invention.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

In a preferred embodiment of the present invention, functionality is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like. The server may be implemented on a cloud or cloud-based computing system.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

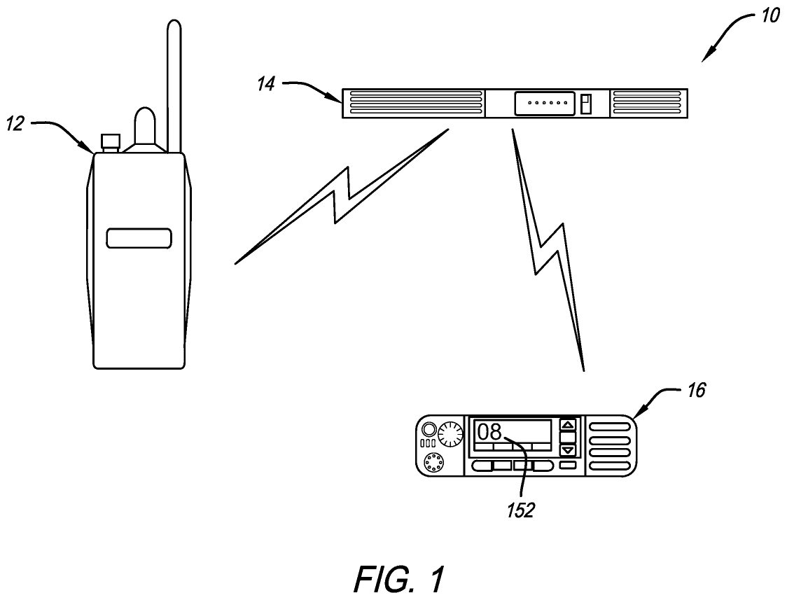

Referring now to the drawings, which are for purposes of illustrating the present invention and not for purposes of limiting the same, the drawings show an interconnected device network facilitating a common machine language between traditional devices of a communication network protocol and IoT interconnected devices. FIG. 1 is a system block diagram of an interconnected device network 10 in accordance with a preferred embodiment of the present invention. The interconnected device network 10 includes a remote device 12 (e.g., a portable, a PTT radio, a two-way radio, or the like), a repeater 14 (e.g., a MOTOTRBO™ digital radio repeater, or the like), and a telemetry control station 16 (e.g., an MQ Telemetry Transport Control Station, or another suitable machine language transport control station).

The remote device 12 is not limited to portable radios, but may include remote cameras, thermometers, or other sensors that use proprietary communication and/or transport protocols. The remote device 12, for example, is an Artificial Intelligence (“AI”) enabled device such as Amazon's Alexa AI voice assistant or other proprietary AI systems. Still further, the remote device 12 may be a security system control, door panel control, or the like, such that a user using a first remote device 12 (e.g., a PTT radio) may control a second remote device 12 (e.g., a restricted access door control).

Preferably, the repeater 14 is a two-way digital radio repeater configured to improve two-way radio communication coverage, and eliminate or reduce dead spots caused by infrastructure interference. The repeater 14 can function to handle communication traffic between multiple remote devices 12 and/or a single site. One of ordinary skill in the art would understand that other suitable replacements, such as an analog repeater, may be utilized without departing from the scope of the present invention.

Preferably, the telemetry control station 16 includes a mobile radio 18 (e.g., a MOTOTRBO™ digital mobile radio), a control module 20 (e.g., an ESP8266/ESP-12F NodeMcu Mini D1 Module), a step-down voltage converter 22 (e.g., a 12V/24V to 5V 3A USB Charger Module DC Buck Step Down Converter), and a wiring harness 24 (e.g., a Motorola rear accessory connector kit). In another embodiment, the telemetry control station 16 does not utilize a mobile radio 18, but instead utilizes the repeater 14 and its rear accessory connector 26.

The mobile radio 18, in a preferred embodiment, is a digital mobile radio including a rear accessory connector 26. The rear accessory connector 26 provides access to General Programmable Input Output (GPIO) pins that may be utilized to allow a user to control and/or monitor external hardware from the mobile radio 18 and/or a remote device 12 configured to communicate with the mobile radio 18, preferably via the repeater 14.

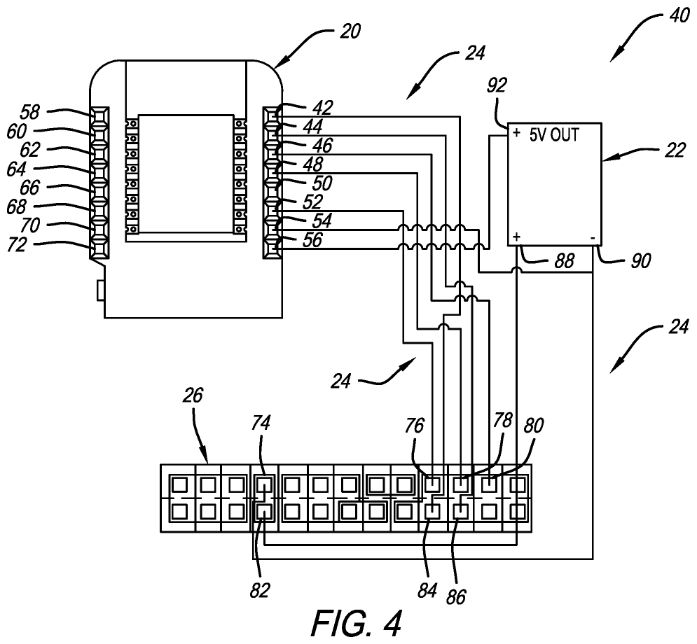

The control module 20 is preferably a nodeMCU control module including wireless connectivity implemented on an integrated system-on-a-chip (“SoC”), such as that offered by the ESP8266/ESP-12F NodeMcu Mini D1 Module, depicted in FIG. 4 as the control module 20. The control module 20, for example, is a microcontroller unit. In other embodiments, the control module 20 includes an embedded microcontroller unit.

The step-down converter 22 is configured to provide DC power to the control module 20 using the mobile radio's 18 power output. For example, the step-down converter 22 is configured to step down DC voltage from 12V to 5V at 3A, suitable to power the ESP8266/ESP-12F NodeMcu Mini D1 Module, for example.

The wiring harness 24 is configured to utilize the rear accessory connector 26 pinout and provide signal and power connectivity to/from the control module 20 and the step-down converter 22.

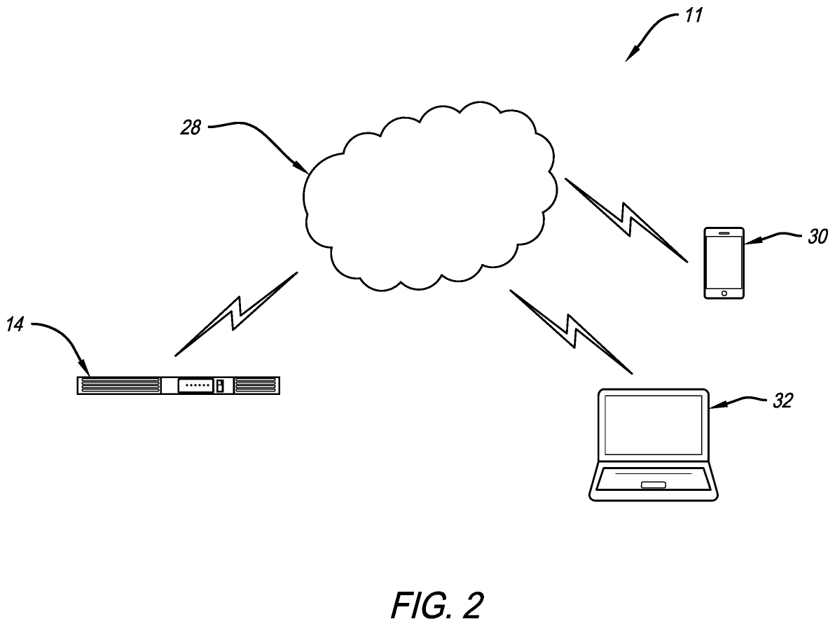

Referring now to FIG. 2, a system block diagram of an interconnected device network 11 in accordance with a preferred embodiment of the present invention is depicted. The interconnected device network 11 preferably includes a cloud 28, a repeater 14, a handheld mobile device 30, and a personal computer 32. The cloud 28 is a combination of software and/or services that run on the Internet, providing on-demand availability of computer system resources including cloud storage and processing. One of ordinary skill in the art would understand that the cloud 28 may consist of a variety of Internet-based systems, software, and services, without departing from the scope of the present invention.

The handheld mobile device 30 and the personal computer 32 are each examples of the remote device 12. The handheld mobile device 30 and the personal computer 32 preferably receive “published” messages (see below regarding the MQTT protocol), and display the published messages on their respective displays 38.

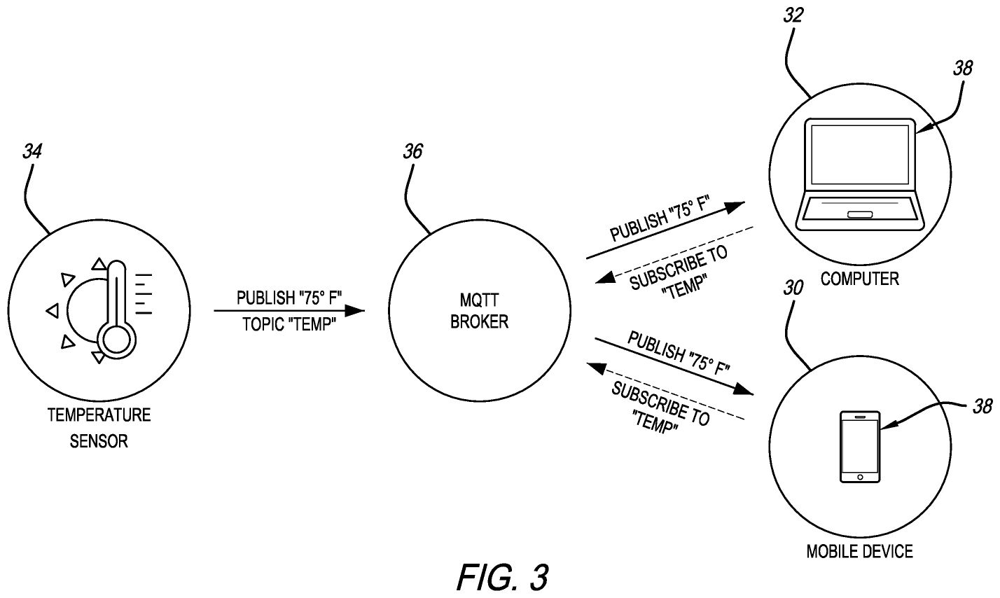

Referring now to FIG. 3, is a system block diagram illustrating a machine language protocol in accordance with a preferred embodiment of the present invention is depicted. The machine language protocol depicted in FIG. 3 is IBM's MQ Telemetry Transport (“MQTT”) protocol, an IoT-based implementation suitable to publish MQTT messages to subscribed clients utilizing an MQTT control packet that includes a fixed header, and in some packets, a variable header, and a payload. MQTT is a Client Server publish/subscribe messaging transport protocol. It is light weight, open, simple, and designed to be easy to implement. These characteristics make it ideal for use in many situations, including constrained environments such as for communication in Machine to Machine (“M2M”) and IoT contexts where a small code footprint is required and/or network bandwidth is at a premium. One of ordinary skill in the art would be familiar with the MQTT messaging transport protocol, the latest version of which (Version 5.0) was published on Mar. 7, 2019. MQTT Version 5.0 is hereby incorporated by reference in its entirety as though fully set forth herein. According to the MQTT specification, the protocol runs over TCP/IP, or over other network protocols that provide ordered, lossless, bi-directional connections. Its features include:
Use of the publish/subscribe message pattern which provides one-to-many message distribution and decoupling of applications.
A messaging transport that is agnostic to the content of the payload.
Three qualities of service for message delivery: (1) “At most once”, where messages are delivered according to the best efforts of the operating environment. Message loss can occur. This level could be used, for example, with ambient sensor data where it does not matter if an individual reading is lost as the next one will be published soon after. (2) “At least once”, where messages are assured to arrive but duplicates can occur. and (3) “Exactly once”, where message are assured to arrive exactly once. This level could be used, for example, with billing systems where duplicate or lost messages could lead to incorrect charges being applied. A small transport overhead and protocol exchanges minimized to reduce network traffic. A mechanism to notify interested parties when an abnormal disconnection occurs.
A small transport overhead and protocol exchanges minimized to reduce network traffic.
A mechanism to notify interested parties when an abnormal disconnection occurs.

FIG. 3 includes a temperature sensor 34, an MQTT broker 36, a mobile device 30, and a computer 32. According to the MQTT protocol, the MQTT broker 36 keeps track of subscribed devices in accordance with a designated topic. For example, as shown in FIG. 2, both the mobile device 30 and the computer 32 have subscribed to the topic “TEMP”. The mobile device 30 and the computer 32 are shown to provide a message to the MQTT broker 36 that indicates they have subscribed to “TEMP”.

The temperature sensor 34 can be any type of thermometer, temperature monitor or sensor, or the like, that is configured to publish a message to the MQTT broker 36. For example, FIG. 3 depicts the temperature sensor 34 publishing “75° F.” relating to the topic “TEMP” to the MQTT broker 36.

The MQTT broker 36 is software running on a computer (either at a location in physical proximity to the user and/or other hardware depicted in FIG. 4), in the cloud 28, or in a combination of the two. The MQTT broker 36, as described above, is configured to receive messages and publish those messages at many subscribed remote devices 12. As shown in FIG. 2, the MQTT broker 36, after receiving the published message “75° F.” relating to the topic “TEMP”, itself publishes the same message “75° F.” relating to the topic “TEMP” to the mobile device 30 and the computer 32.

Referring now to FIG. 4, a system block diagram of a telemetry control station 40 in accordance with a preferred embodiment of the present invention is depicted. The telemetry control station 40 includes a control module 20, a step-down voltage converter 22, a wiring harness 24, and a rear accessory connector 26. In an embodiment, the rear accessory connector 26 is a connector on the rear portion of a mobile radio 18. In another embodiment, the rear accessory connector 26 is a connector on the rear portion of a repeater 14.

As described above in connection with FIG. 1, the control module 20 is preferably a nodeMCU control module including wireless connectivity implemented on an embedded SoC. The control module 20 depicted in FIG. 4 generally provides a pin input/output corresponding to the ESP8266/ESP-12F NodeMcu Mini D1 Module and other similar control modules configured with an integrated ESP8266 SoC. The control module 20 generally follows a General Programmable Input Output (“GPIO”) pinout. The control module 20 includes 16 visible pins, namely a TX pin 42 corresponding to GPIO1, an RX pin 44 corresponding to GPIO3, a D1 pin 46 corresponding to GPIO5, a D2 pin 48 corresponding to GPIO4, a D3 pin 50 corresponding to GPIO0, a D4 pin 52 corresponding to GPIO2, a GND pin 54 (e.g., ground), a 5V pin 56, an RST pin 58, an ADC0 pin 60, a D0 pin 62 corresponding to GPIO16, a D5 pin 64 corresponding to GPIO14, a D6 pin 66 corresponding to GPIO12, a D7 pin 68 corresponding to GPIO13, a D8 pin 70 corresponding to GPIO15, and a 3V3 pin 72. One of ordinary skill in the art would understand that various pinouts exist for ESP8266 control modules depending on the desired application and manufacturer.

The step-down voltage converter 22 depicted in FIG. 4 includes a 12V+/− input terminals 88, 90, corresponding to positive and negative terminals, respectively, and a 5V+ OUT terminal 92.

The rear accessory connector 26 depicted in FIG. 4 includes a pinout corresponding to Motorola standards. The rear accessory connector 26 includes 26 numbered pin inputs corresponding to functional inputs/outputs of the control station 16. One of ordinary skill in the art would understand that other proprietary and non-proprietary control stations and pinouts would be within the scope of the present invention. For example, the rear accessory connector 26 is the DM4000 series accessory connector provided by Motorola. See Table 1 below for a mapping of Pin No. to Pin Name. The rear accessory connector 26 pinouts include a Power Ground pin 74 (Pin No. 8), a GP5_6 pin 76 (Pin No. 20), a GP5_7 pin 78 (Pin No. 22), a GP5_8 pin 80 (Pin No. 24), an SW B+ pin 82 (Pin No. 7), a GP5_2 (Monitor) 84 (Pin No. 19), and a GP5_3 (Chan Act) pin 86 (Pin No. 21). As can be seen from Table 1, other pins and functions are available utilizing the rear accessory connector 26.

To provide 12-volt power to the step-down voltage converter 22, the SW B+ pin 82 and the 12V+ input terminal 88 are wired together, and the Power Ground pin 74 and the 12V− input terminal 90 are wired together. To provide 5-volt power to the control module 20, the 5V+ OUT terminal 92 and the 5V pin 56 are wired together, and the Power Ground pin 74 and the GND pin 54 are wired together. The wiring harness 24 is utilized to wire these pins together.

Still referring to FIG. 4, the GP5_6 pin 76 is wired to the D4 pin 52. The GP5_6 pin 76 is configured to provide 5V level GPIO to GPIO2 of the control module 20. The GP5_7 pin 78 is wired to the D2 pin 48. The GP5_7 pin 78 is configured to provide 5V level GPIO to GPIO4 of the control module 20. The GP5_8 pin 80 is wired to the D1 pin 46. The GP5_8 pin 80 is configured to provide 5V level GPIO to GPIO5 of the control module 20. The GP5_2 (Monitor) 84 is wired to the TX pin 42. The GP5_2 (Monitor) pin 84 is configured to provide 5V level GPIO and Monitor Input to GPIO1 of the control module 20. The GP5_3 (Chan Act) pin 86 is wired to the RX pin 44. The GP5_3 (Chan Act) pin 86 is configured to provide 5V level GPIO and Channel Activity Function to the control module 20.

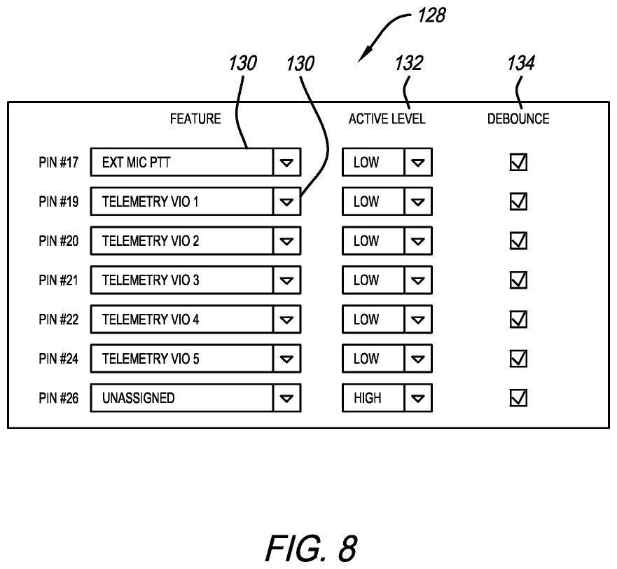

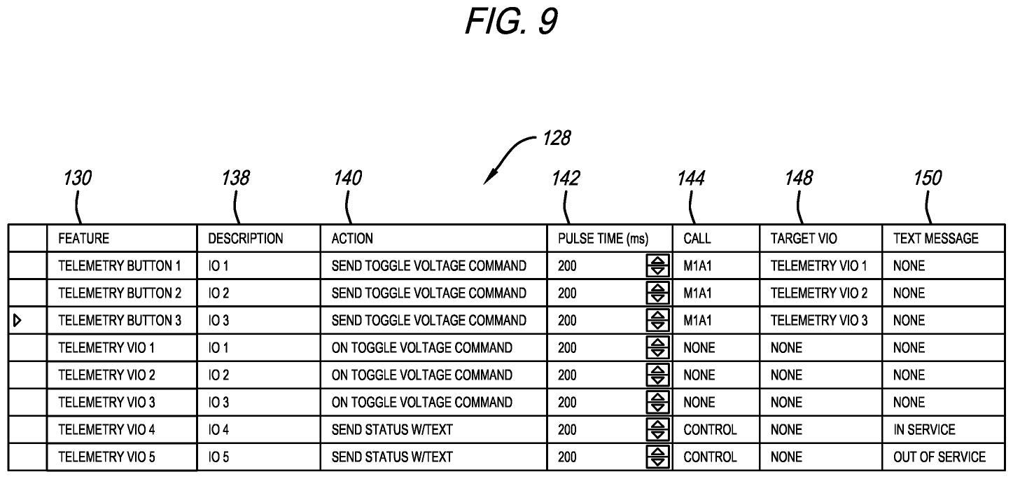

Referring to FIG. 8, a diagram of a telemetry command programming tool 128 in accordance with a preferred embodiment of the present invention is disclosed. The telemetry command programming tool 128 includes a telemetry feature 130, an active level field 132, and a debounce function 134. The telemetry command programming tool 128 is configured to map a physical pin of the rear accessory connector 26 to the telemetry feature 130. Each pin/telemetry feature 130 is depicted next to a corresponding active level 132. The active level field 132 is set either to “Low” or “High” depending on the preferred application. The debounce function 134 prevents false triggers from poor electrical contacts.

Referring now to FIG. 9, a diagram of a telemetry command programming tool 136 in accordance with a preferred embodiment of the present invention is disclosed. the telemetry command programming tool 136 includes a telemetry feature field 130, a description field 138, an action command 140, a pulse time 142, a call command 144, a target VIO field 148 and a text message field 150. The telemetry The telemetry feature 130 is utilized to map the telemetry input (e.g., a Telemetry Button 1, for example, as shown in FIG. 9) to a particular pin GPIO. For example, Telemetry Button 1 is a physical button on a remote device 12 (e.g., a PTT radio 12) that, when depressed by a user, triggers a 200 ms pulse in accordance with the pulse time 142 and an action command 140 of “Send Toggle Voltage Command” in accordance with the specified call command 144. The action command 140 thus instructs the voltage to be toggled from “LOW” to “HIGH”, or visa versa. In this example, the call command 144 is M1A1. M1A1 may be, for example, a MQTT topic configured to be routed via MQTT to an MQTT broker, and subsequently, to a subscriber. The target VIO field 148 indicates “Telemetry VIO 1” which, from FIG. 9, is identified under the telemetry feature 140 and includes a description field 138 of “IO 1”.

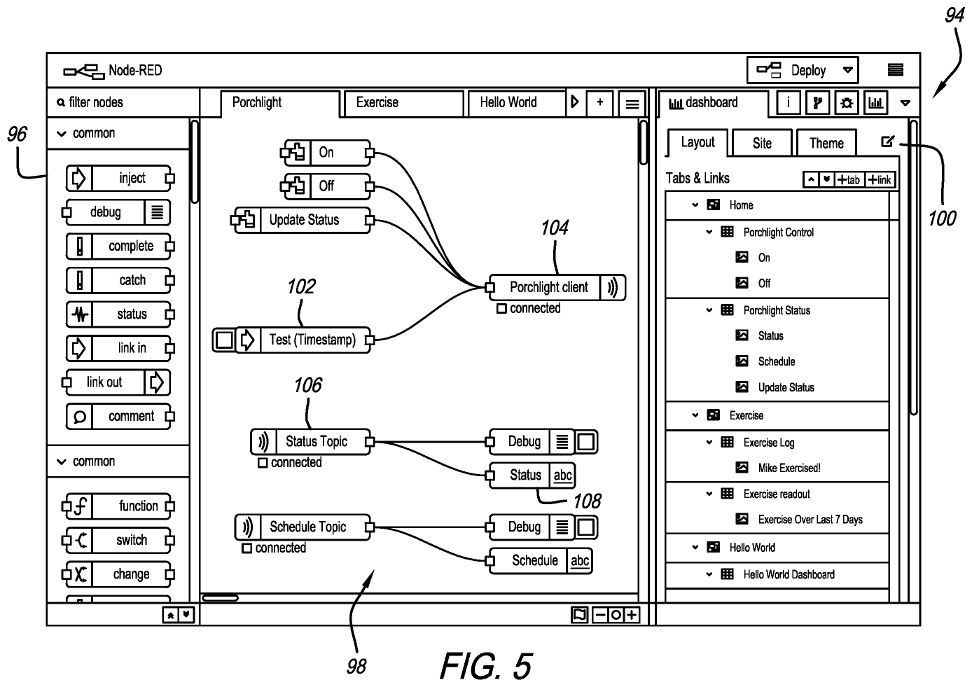

Once the corresponding action command 140 of “On Toggle Voltage Command” is received, the voltage is toggled from “HIGH” to “LOW” and visa versa through an additional telemetry message. In this example, Pin No. 19 shown in FIG. 8 is mapped to Telemetry VIO 1, and is associated with IO 1 in the description field 138 of FIG. 9. For example, Telemetry VIO 1 may be associated with Pin No. 19; in the example shown in FIG. 5, Pin No. 19 is configured to provide 5V level GPIO to GPIO1 at the control module 20. Utilizing these features, a telemetry message may be sent from a remote device 12 through the interconnected device network 10, 40 to another remote device 12. A telemetry message preferable includes a unique identification 152 associated with the control station 16, a telemetry feature 130, and an action command 140. For example, the unique identification 152 associated with the control station 16 as shown in FIG. 1 is “08”.

As can be seen from FIG. 9, a variety of input/output telemetry messages 130 may be implemented. For example, a telemetry message may provide an action command 140 of “Send Status w/Text”. The telemetry message will be routed to the call command 144 identified as “Control” and the text “IN Service” may be displayed on the remote device 12. For example, “Control” is an MQTT topic to which the remote device 12 is subscribed.

The telemetry command programming tools 128, 136, as depicted in FIGS. 8-9, support three virtual telemetry programmable buttons (e.g., Telemetry Button 1-3). The tools 128, 136 may also support three telemetry VIO entries (e.g., Telemetry VIO 1-3) for portable radios 12 and five entries for control stations 16 or other mobile radios 12. The user may send telemetry messages that include action commands 140 by assigning the virtual Telemetry Buttons 1-3 to a short or long programmable button press or assigning and asserting a GPIO pin to its active level. When multiple input GPIOs (e.g., Telemetry Button) are assigned to a single VIO (e.g., Telemetry VIO), a voltage change on any of the input GPIOs will trigger the VIO.

Referring now to FIG. 5, a diagram of an event-driven application graphical user interface in accordance with a preferred embodiment of the present invention is disclosed. The GUI depicted in FIG. 5 includes an exemplary GUI editor 94 typical of that employed in Node-RED via a web browser. The GUI editor 94 includes a palette 96, a workspace 98, and a dashboard 100. The workspace 98 shows an MQTT input node 102 and an MQTT output node 104. The configuration of the MQTT input node 102 and the MQTT output node 104 is set to “publish” a topic message to subscribers. The workspace 98 also shows a “subscriber” flow in which a schedule topic node 106 is wired to a schedule node 108. One of ordinary skill in the art would recognize that the GUI editor 94 includes a variety of other portions, a description of which is available at nodered.org and incorporated herein by reference as though fully set forth herein.

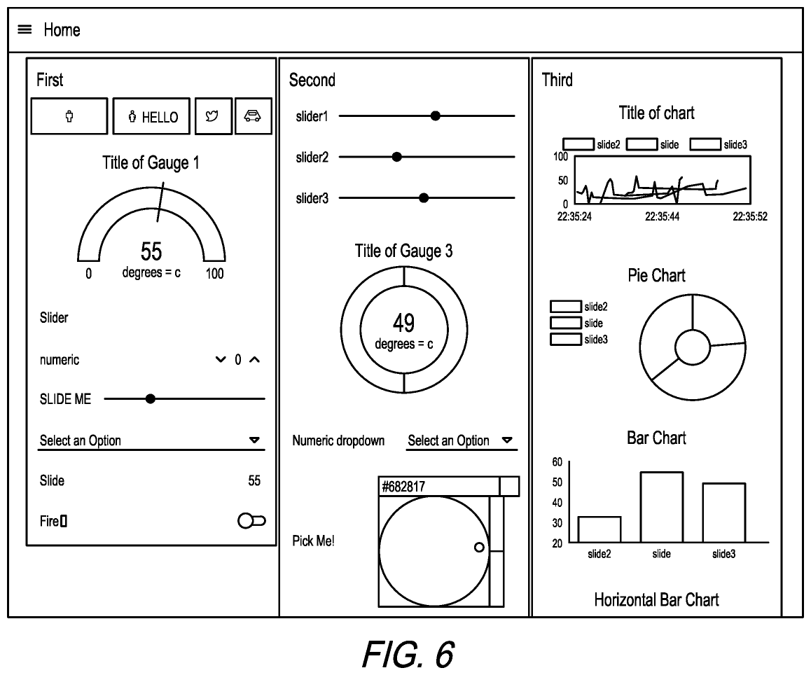

FIG. 6 is a web-based graphical user interface generated by an event-driven application in accordance with a preferred embodiment of the present invention. The GUI is configured to interact with an MQTT broker 36 to control desired functions at a remote device 12 and/or to read data at a remote device 12. One of ordinary skill in the art would understand that the GUI depicted in FIG. 6 may graphically show a user a variety of data fields and provide a variety of control options and not depart from the scope of the present invention.

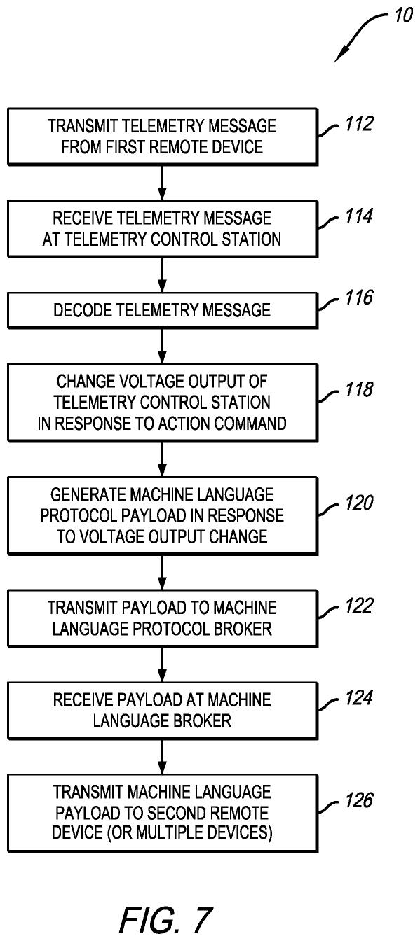

FIG. 7 is a flow diagram of a method 110 of providing a common machine language network in accordance with a preferred embodiment of the present invention. The method 110 preferably utilizes the telemetry command programming tools 128, 136 to provide telemetry functionality to remote devices 12. The method 110 generally utilizes a telemetry control station 16, 40 to provide the telemetry messages to an MQTT subscriber via an MQTT broker 36. Accordingly, the method and system disclosed herein blends telemetry messaging and machine language protocol-implemented hardware. For example, the method 110 blends MOTOTRBO telemetry and an ESP8266 MQTT client. The blending permits any off-the-shelf radio to generate and receive MQTT messages using an existing Land Mobile Radio (“LMR”) radio interface. The method 110 demonstrates an exemplary inbound path to generate a message into an MQTT broker 36, but can easily be reversed to permit an information flow from the MQTT broker 36 to a fleet of PTT radios 12.

Using the telemetry control station 40, for example, a user may control GPIO pins of their own PTT radio 12 or another radio, including a mobile radio 18 or control station 16, 40. The external hardware attached to the control station 40 as depicted in FIG. 4, for example, permits the user to control and monitor the external hardware from their own radio 12.

At Step 112, a telemetry message is transmitted from a first remote device 12. As an example, the telemetry message includes a unique identification 152 of a telemetry control station 16, a telemetry feature 130, and an action command 140. The telemetry message is a message hereinbefore described as being generated by the remote device 12. For example, the telemetry message is generated by a PTT radio 12.

At Step 114, the telemetry message is received at the telemetry control station 16. The telemetry control station 16, in this embodiment, is the telemetry control station 40. At Step 116, the telemetry message is decoded by the telemetry control station 40. For example, the mobile radio 18 decodes the telemetry message. In another embodiment, the repeater 14 decodes the telemetry message.

At Step 118, a voltage output of the telemetry control station 40 is changed in response to an action command 140 of the telemetry message. For example, as described in connection with the telemetry command programming tools 128, 136, the voltage output of accessory pin GPIO2 (Pin No. 19) is changed from active “HIGH” to active “LOW” (e.g., ground). In this example, the action command 140 is “On Toggle Voltage Command”.

At Step 120, a machine language protocol payload is generated in response to the voltage output change. Preferably, the machine language protocol payload is an MQTT payload configured to be transmitted to an MQTT broker 36. As described herein, the MQTT packet includes a fixed header, and optionally, a variable header and a payload. In this example, the MQTT packet includes at least a fixed header and an MQTT payload. Thus, the machine language protocol payload is configured to be transmitted to the machine language protocol broker 36. Subsequently, at Step 122, the machine language protocol payload is transmitted to the machine language protocol broker 36. At Step 124, the machine language protocol payload is received at the machine language protocol broker 36.

At Step 126, the machine language protocol payload is transmitted by the machine language protocol broker 36 to a second remote device 12. In an embodiment, the broker 36 transmits the machine language protocol payload to a plurality of second remote devices 12. As described herein, the MQTT broker 36 provides the MQTT packet, including the MQTT payload, to all subscribers to a particular topic. In an example, and in connection with FIGS. 8-9, the MQTT payload may be a text message of “IN Service” to be displayed by the second remote device 12, and the topic may be “Control”. One of ordinary skill in the art would understand that a variety of commands and statuses may be sent and received by remote devices 12 in accordance with the methods described herein without departing from the scope of the present invention.

While many embodiments are described herein, at least some of the described embodiments provide an apparatus, system, and method for an interconnected device network.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. An interconnected device network comprising:
a first remote device configured to transmit a telemetry message;
a telemetry control station configured to receive the telemetry message comprising a unique identification associated with the telemetry control station, a telemetry feature, and an action command;
a control module configured to receive the telemetry message from the telemetry control station, decode the telemetry message, and generate a machine language protocol payload from the telemetry message in accordance with the action command; and
a machine language broker configured to receive the machine language protocol payload and transmit the machine language protocol payload to at least one second remote device.

2. The interconnected device network of claim 1, further comprising an event-driven application configured to provide accessibility between the control station, the at least one remote device, and application programming interfaces, wherein at least two of the control station, the at least one remote device, and the application programming interfaces do not communicate through the same machine language protocol.

3. The interconnected device network of claim 1, wherein the control module is further configured to receive a voltage input, wherein the machine language protocol payload is generated by the control module when the control module receives a change in the voltage input.

4. The interconnected device network of claim 1 further comprising a repeater configured to relay the telemetry message from the first remote device to the telemetry control station.

5. The interconnected device network of claim 1, wherein the telemetry control station is an MQ telemetry transport control station.

6. The interconnected device network of claim 1, wherein the event-driven application is node-RED.

7. The interconnected device network of claim 1, wherein the machine language broker is further configured to maintain a subscribed list, wherein the subscribed list tracks a topic and the at least one second remote device subscribed to the topic.

8. The interconnected device network of claim 1, wherein the machine language protocol payload is a portion of a machine language protocol packet configured to be transmitted and received through a wireless network.

9. A method of providing a common machine language network, the common machine language network comprising the steps of:
transmitting a telemetry message from a first remote device, the telemetry message comprising a unique identification associated with a telemetry control station, a telemetry feature, and an action command,
receiving the telemetry message at the telemetry control station, the telemetry control station configured to decode the telemetry message and change a voltage output in response to the action command,
generating a machine language protocol payload in response to the voltage output change, wherein the payload is configured to be transmitted to a machine language protocol broker,
receiving the payload at the machine language protocol broker, and
transmitting the machine language protocol payload to at least one second remote device via the machine language protocol broker.

10. The method of claim 9, the method further comprising the step of relaying the telemetry message from the first remote device to the telemetry control station.

11. The method of claim 9, wherein the telemetry control station is an MQ telemetry transport control station.

12. The method of claim 9, wherein the machine language broker is configured to maintain a subscribed list, wherein the subscribed list tracks a topic and the at least one second remote device subscribed to the topic.
